(19) United States
(12) Patent Application Publication
(10) Pub. No.: US 2018/0149301 A1
(43) Pub. Date: May 31, 2018

(54) PIG AND PIGGING METHODS FOR GAS PIPELINES

(71) Applicant: Naveed Aslam, Houston, TX (US)

(72) Inventor: Naveed Aslam, Houston, TX (US)

(21) Appl. No.: 15/362,088

(22) Filed: Nov. 28, 2016

(51) Int. Cl. F16L 55/40; F16L 55/46; B08B 9/055

(52) U.S. Cl. CPC F16L 55/40; F16L 2101/12; B08B 9/0553; F16L 55/46

(57) ABSTRACT

A deformable pig and method of pigging are disclosed. The deformable pig is an outer shell having a hollow, spherical shape and a deformable core material contained within the outer shell. The deformable core material may be a shape memory polymer foam which will contour to bends in a pipeline being treated. This enables effective cleaning of the pipeline while inhibiting the pig from getting stuck in the pipeline. Alternatively, the deformable pig may be made from the shape memory polymer foam and be rectangular shaped without an outer shell material.

### BACKGROUND OF THE INVENTION

Hydrocarbons are frequently transported via pipeline systems which can be situated in a number of locations such as underground, undersea or above ground. These pipelines will become dirty through this contact with the hydrocarbons and contaminants therein. Gases are typically used to clean these impurities in pipelines and related process equipment as their pressure force transfers its momentum to trapped solid or liquid particles, and removes these deposits through mechanical force.

Typically an inert gas such as nitrogen or argon is used for this purpose. However, these gases tend to have limited utility as most solid and liquid contaminants and impurities are not readily soluble in inert gases. Combine this with limitations of momentum transfer from gas to impurity and their removal mechanisms can be somewhat limited.

Alternatively pigs are employed to clean the pipelines. These pigs are based on high density solid materials and are inserted into the pipeline where the flow of the hydrocarbons pushes it down the pipe. The pig will contact the sides of the pipeline and clean off impurities, all without stopping the flow of the hydrocarbons in the pipeline.

However, pigs also have certain drawbacks due to their size and weight and particularly with respect to variations in pipeline conditions.

For example, 42% of natural gas lines and 11% of liquid lines in the United States cannot accommodate traditional pigs due to physical limitations. The piggability of a specific pipeline is not a very well defined metric and could vary from service to region.

Typical key factors in defining piggability are length of the pipeline. The distance between two pig traps is variable and can cause a wear and tear and loss of functionality of pigs as evidenced by natural gas pipelines having 50 to 100 miles between traps. This is further an issue where refined products are 100 to 150 miles between traps and crude oil pipelines are 150 to 200 miles between traps. Additionally, dual diameter pipelines and reducers are variable. Linings are used in pipelines to protect the inside of the pipe from the effects of the products travelling therein and to create less resistance. Pigs can damage these linings which can lead to pipeline failure. Bends need to be forged, particularly when the radius of the pipeline is small and solid pigs can get stuck at these bends. Further field bends can cause local deformations exceeding 2 to 3% of the pipeline diameter which can cause problems for the pig travelling through the pipeline.

Additionally miter bends, wall thickness variations, tees, off-takes, barred tees, valves and check valves, pipe elevations and spans and non-engineered spans, drips, siphons and pipeline carrots and coupon holders all introduce variables in the pipeline that make traditional pigging operations problematic.

The lightweight, deformable multifunctional pig proposed by the present invention will provide solutions to the problems these many variables present.

### SUMMARY OF THE INVENTION

In a first embodiment of the invention, there is disclosed a deformable pig comprising a shell and a foam filled core.

More specifically, the invention relates to a deformable pig comprising an outer shell having a hollow, spherical shape and a deformable core material contained within the outer shell.

The deformable core material is a shape memory effect (SME) polymer foam.

Typically the deformable core may be made of polyurethanes, polysilicons, and polyethylene along with a wax which could act as a switching mechanism as the mechanical pressure increases, the temperature increases thereby releasing the heat of crystallization. This change in temperature triggers the change in shape. The shape memory effect (SME) in polymers can be triggered through mechanical force such as impact or pressure. Polymers such as polytetrafluoroethylene (PTFE), polyactide (PLA) and ethylene-vinyl acetate (EVA) in combination with certain materials can release the latent heat of crystallization thereby providing another design matrix of SMEs that may have utility in the invention.

One potential mechanism of SME could be achieved by combining silicone with a wax and a salt. The silicone-wax hybrid could be multiple-stimuli responsive SME. For example, utilizing the latent heat generated during the crystallization of salt, the polymer hybrid matrix could self-heat for shape change or recovery. The initialization of crystallization in a room temperature liquid could be generated through a gentle disturbance or pressure. A wax could be selected which is brittle at room temperature thereby allowing for the impact/pressure induced material to be designed.

The outer shell can be a fiber reinforced composite. The outer shell material can be polystyrene, metal or polymer with metal brushes like stainless steel or aluminum. The outer shell is thereby stiffer and has less flexibility to change in response to pressure or induced force.

Alternatively, condensation polymers can be useful as the outer shell material as they provide the requisite mechanical strength while being relatively inflexible. For example, Nylon 55, a polyamide, could be formed into high strength fibers which could be installed on the outer shell of the pig. Further, the outer shell could be prepared from condensation polymers and metal or steel wires incorporated therein. The condensation polymer will typically have a higher glass transition (Tg) temperature such as polycarbonate (Lexan) or Polyamide (Nomex) which could provide a fairly inflexible outer shell that is fairly hard while having a rough surface to provide mechanical cleaning of the pipeline. However, lower Tg materials such as polyester (Dacron) or polyamide (Nylon 66) can be effective as the outer shell material.

The following table lists several condensation polymers that may prove useful as the outer shell material. Accordingly, the outer shell material may be selected from the group consisting of polyesters, polycarbonates, polyamides, and polyurethanes.

| Formula | Type | Components | T_{g} ° C. | Tₘ ° C. |
|---|---|---|---|---|
| | polyester | para HO₂C—C₆H₄—CO₂H | 70 | 265 |
| | Dacron ® | HO—CH₂CH₂—OH | | |
| | Mylar ® | | | |
| | polyester | meta HO₂C—C₆H₄—CO₂H | 50 | 240 |
| | | HO—CH₂CH₂—OH | | |
| | polycarbonate | (HO—C₆H₄—)₂C(CH₃)₂ | 150 | 267 |
| | Lexan | (Bisphenol A) | | |
| | | X₂C═O | | |
| | | (X = OCH₃ or Cl) | | |
| ~[CO(CH₂)₄CO—NH(CH₂)₆NH]ₙ~ | polyamide | HO₂C—(CH₂)₄—CO₂H | 45 | 265 |
| | Nylon 66 | H₂N—(CH₂)₆—NH₂ | | |
| ~[CO(CH₂)₅NH]ₙ~ | polyamide | | 53 | 223 |
| | Nylon 6 | | | |
| | Perlon | | | |
| | polyamide | para HO₂C—C₆H₄—CO₂H | — | 500 |
| | Kevlar | para H₂N—C₆H₄—NH₂ | | |
| | polyamide | meta HO₂C—C₆H₄—CO₂H | 273 | 390 |
| | Nomex | meta H₂N—C₆H₄—NH₂ | | |
| | polyurethane | HOCH₂CH₂OH | 52 | — |
| | Spandex | | | |

The core is bonded to the shell through covalent or non-covalent bonding mechanisms. In the case where covalent bonding is present, a curing process will be followed to ensure that bonding is robust. The core and shell can also be attached through a physical stitching mechanism.

The invention further describes a deformable pig that comprises a rectangular shaped memory polymer foam. The deformable pig that comprises a rectangular shaped memory polymer foam would typically be a polystyrene mixed with EVA, PVA, vinyl alcohol, ethylene EVOH, or polyvinylidene chloride. Among these different rigid and flexible polymers the hydrogen bonding is created through the curing process.

The invention further comprises a method for cleaning a pipeline comprising pigging the pipeline with a pig comprising a deformable pig comprising an outer shell having a hollow, spherical shape and a deformable core material contained within the outer shell.

The deformable pig is launched into the pipeline from a pig launcher and will contact the walls of the pipeline thereby to remove deposits and impurities deposited thereon.

The method of pigging can be performed on a variety of pipelines such as natural gas, refined products and crude oil pipelines.

In another embodiment of the invention, there is disclosed a method for maintaining a functional line for conveying fluid comprising introducing a deformable pig into the pipeline wherein the deformable pig comprises an outer shell having a hollow, spherical shape and a deformable core material contained within the outer shell.

Pigs are typically launched in live pipelines. Operators will use the correct type of pig and schedule frequency of pigging to maintain pipeline integrity and flow efficiency. The operator will also be able to determine what the specific issues are with a pipeline such as type of clogging or other hold-up and can therefore select the right pig design to clean the particular problem so diagnosed.

A pipeline that can be pigged should be pigged at least annually to inhibit the effects of corrosive liquids and solids hold-up. The cleaning or utility pig when run on stream will have the speed of the pig dictated by the flowrate of the product passing through the pipeline. Typically these flow rates are between 10 and 17 feet per second (fps).

For effective utility pigging, the typical speeds are as follows: for pipeline pre-commissioning or commissioning 1 to 5 miles per hour or 1.5 to 7.5 feet per second; routing gas pigging is 2 to 8 miles per hour or 3 to 12 feet per second; routing liquid pigging equals 1 to 8 miles per hour or 1.5 to 12 feet per second; ILI tool runs are 2 to 7 miles per hour or 3 to 10 feet per second.

An advantage of the pigs used in the present invention is that no special crane to launch or special mechanism to retrieve the pig is necessary.

The deformable pigs of the present invention are anticipated to be effective in the conditions typically encountered for gas pipelines.

The deformable pig of the present invention can be applied for many cycles of operation before it must be replaced by a new pig. The pig upon retrieval can be washed, dried in nitrogen and introduced into the pipeline again. It is anticipated by the present inventor that the deformable pigs of the present invention will have lifetimes comparable with if not longer than metal based traditional pigs.

The inventor anticipates that the deformable pigs of the present invention can be used for petrochemical lines as well as oil and gas pipelines.

The deformable pig may also be used as an intelligent pig whereby electronics and sensors that collect various forms of data during its trip through the pipeline. So for example, the outer shell or the deformable foam material may be fitted with sensors or devices for the monitoring of corrosion or pipeline defects; release of corrosion inhibitor; internal pipeline imaging; data transmission; and micro-motion sensor to generate power for the instruments. For example, the inner core of a deformable pig according to the methods of the present invention is made of foam cells and has a gel like structure. These closed or semi closed cells could be loaded with a corrosion inhibitor which can then be released inside the pipeline.

The outer shell surface can be configured or textured to scrape impurities off of the pipeline wall.

### BRIEF DESCRIPTION OF THE DRAWINGS

FIG. 1 is a schematic showing a pig having a deformable shell and core per the invention.

FIG. 2 is a schematic showing the deformable pig in various deformations as may be encountered in a pipeline.

FIG. 3 is a schematic of a deformable pig with various functional objects integrated therein.

FIG. 4 is schematic of a deformable pig comprising core shape memory polymer foam.

FIG. 5 is a schematic of a pipeline that contains bends and the relative positions of a deformable pig comprising core shape memory polymer foam,

### DETAILED DESCRIPTION OF THE INVENTION

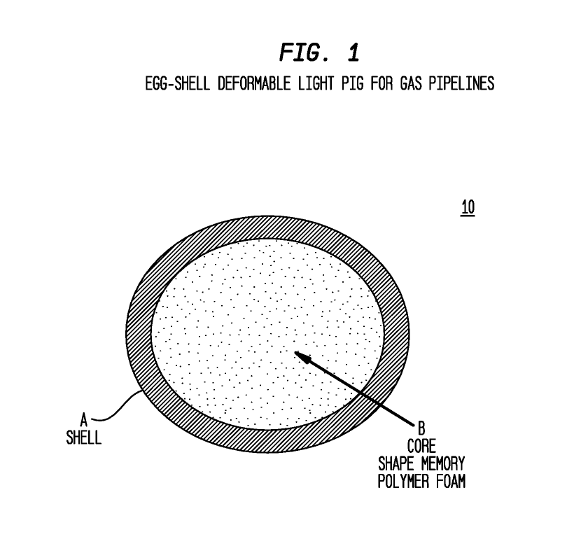

FIG. 1 is a schematic of a deformable pig that comprises an outer shall having a hollow, spherical shape and a deformable core material that is contained within the outer shell. The deformable pig 10 will comprise the outer shell A which is a hollow, spherical shape. This allows for inclusion of a core shape memory polymer foam material B to be present inside the hollow. Typically the deformable pig 10 has the dimensions that are suitable for the diameter of the pipeline that is undergoing the pigging operation.

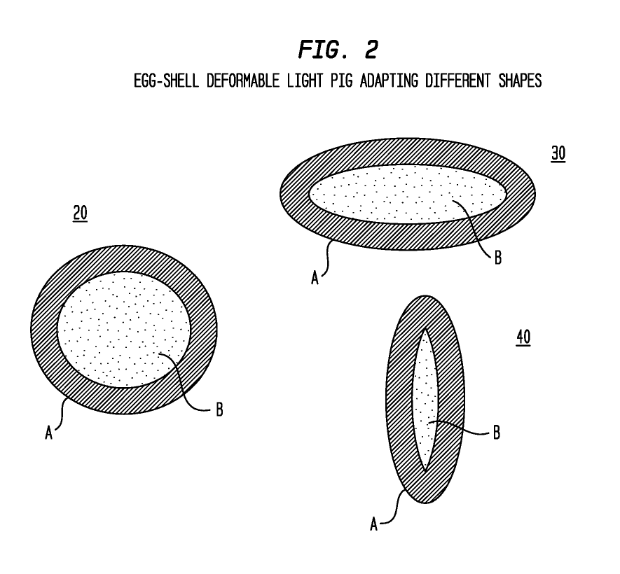

FIG. 2 shows the deformable pig as described in FIG. 1 in various configurations. The designations A and B are the same as employed for use in the description of FIG. 1. Deformable pig 20 shows the deformable pig as a round spherical shape as it would look when launched into the pipeline to be treated.

Deformable pig 30 shows a compressed deformable pig as it may encounter a change in the dimensions of the pipeline being treated. Likewise, deformable pig 40 is compressed in a different manner as it contours itself to fit the pipeline that is being treated.

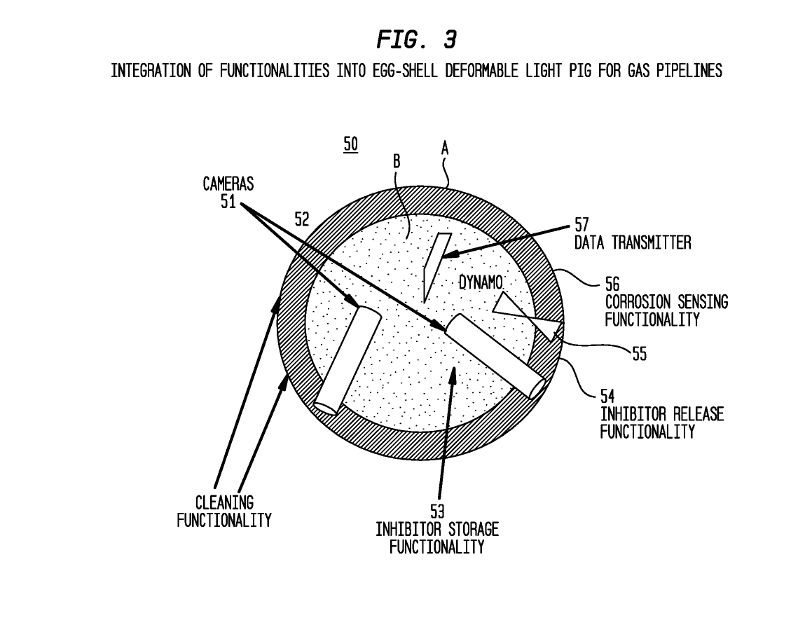

FIG. 3 depicts the deformable pig 50 with a variety of sensors and instrumentation. Typically one or more of these devices may be present in the deformable pig 50 as well as all of them being present. The designations A and B are as described again for FIG. 1 with the outer shell A contacting the inner lining of the pipeline that is being treated by the deformable pig 50.

Cameras labeled 51 and 52 may be employed to provide visual verification of the surface of the pipeline that is being treated. The deformable core material B may be configured to store inhibitor 53 which can be released as a corrosion inhibitor for example if corrosion is detected. This is facilitated by the inhibitor release functionality 54 as may be built into the outer shell material of the deformable pig 50.

A dynamo 55 may be present inside of the deformable core material B or straddling between the deformable core material B and the outer shell A. This dynamo can produce electricity which can power the devices and sensors that are present in or on the deformable pig 50.

The deformable pig 50 may also have a corrosion sensing functionality 56 on the surface of outer shell material A. These sensors can detect pitting and other corrosion in the inner walls of the pipeline so that the operator can determine if there is a need for addition of corrosion inhibitor or more stringent restorative efforts.

A lot of pipelines are fabricated from steel and are buried underground or undersea. Given these circumstances it can be difficult to have radio communications with the pig. However, deformable pig 50 can contain a data transmitter 57 which is present in the deformable core material B and can gather and transmit various data to the operator of the pipeline after the deformable pig has been retrieved from the pipeline. This data can include the actual coordinates that the pig traversed during its run in the pipeline. It can include any visual or other footage captured by the cameras 51 and 52, as well as any corrosion or pitting data that is captured by the corrosion sensing functionality 56.

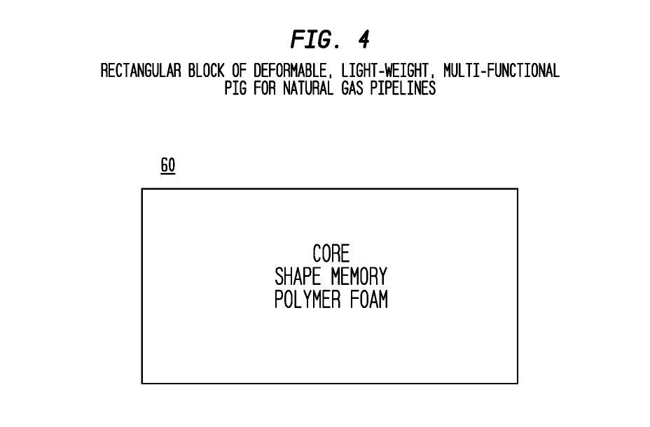

FIG. 4 is a schematic showing a rectangular block of core shape memory polymer foam 60 that can be deployed as the deformable pig. Unlike the spherical shaped deformable pig that has been described above, there is no outer shell present.

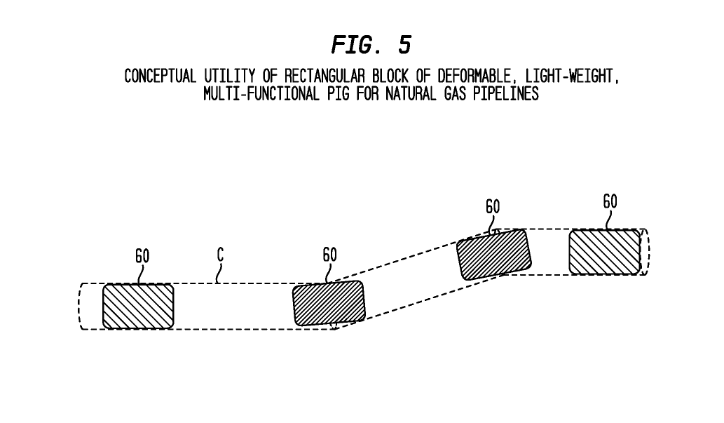

FIG. 5 is a depiction of a pipeline C that has bends in it. These bends can be due to the actual physical construction of the pipeline where bends are build in to accommodate naturally occurring phenomena or because of ground shifts and other natural occurrences that cause the pipeline to bend in spots.

The rectangular block of core shape memory foam as described above is labeled 60 and operates as the deformable pig. This depiction shows the progression of the deformable pig 60 through the pipeline from left to right noting that at least two points there is a slight bend in the pipeline which the deformable pig not only provides cleaning but also traverses these bends which traditional pigs may not accomplish.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A deformable pig comprising a shell and a deformable core material.

2. The deformable pig as claimed in claim 1 wherein the deformable core material is a shape memory effect polymer foam.

3. The deformable pig as claimed in claim 1 wherein the deformable core material comprises a material selected from the group consisting of polyurethanes, polysilicons and polyethylenes.

4. The deformable pig as claimed in claim 2 wherein the deformable core material further comprises a wax.

5. The deformable pig as claimed in claim 1 wherein the deformable core material comprises a polymer selected from the group consisting of polytetrafluoroethylene, polyactide and ethylene-vinyl acetate.

6. The deformable pig as claimed in claim 1 wherein the deformable core material comprises a silicone-wax hybrid.

7. The deformable pig as claimed in claim 6 wherein the silicone-wax hybrid is formed by combining silicone, wax and a salt.

8. The deformable pig as claimed in claim 1 wherein the shell is selected from the group consisting of fiber reinforced composites, polystyrene, metal and polymers selected from the group consisting of polyesters, polycarbonates, polyamides, and polyurethanes.

9. The deformable pig as claimed in claim 8 wherein the shell further comprises metal brushes,

10. The deformable pig as claimed in claim 1 wherein the deformable core material is bonded to the shell through a bond selected from the group consisting of covalent and noncovalent bonding.

11. The deformable pig as claimed in claim 1 which is rectangular in shape.

12. The deformable pig as claimed in claim 1 wherein the deformable core material is a polystyrene mixed with a polymer selected from the group consisting of EVA, PVA, vinyl alcohol, ethylene EVOH and polyvinylidene chloride.

13. The deformable pig as claimed in claim 1 further comprising a shell that is fitted with sensors.

14. The deformable pig as claimed in claim 13 wherein the sensors are selected from the group consisting of sensors for monitoring corrosion, monitoring pipeline defect, pipeline imaging, and for generating power.

15. The deformable pig as claimed in claim 1 further comprising a shell loaded with a corrosion inhibitor.

16. The deformable pig as claimed in claim 1 wherein the shell is textured.

17. A deformable pig comprising an outer shell having a hollow, spherical shape and a deformable core material contained within the outer shell.

18. The deformable pig as claimed in claim 17 wherein the deformable core material is a shape memory effect polymer foam.

19. The deformable pig as claimed in claim 17 wherein the deformable core material comprises a material selected from the group consisting of polyurethanes, polysilicons and polyethylenes.

20. The deformable pig as claimed in claim 19 wherein the deformable core material further comprises a wax.

21. The deformable pig as claimed in claim 17 wherein the deformable core material comprises a polymer selected from the group consisting of polytetrafluoroethylene, polyactide and ethylene-vinyl acetate.

22. The deformable pig as claimed in claim 17 wherein the deformable core material comprises a silicone-wax hybrid.

23. The deformable pig as claimed in claim 22 wherein the silicone-wax hybrid is formed by combining silicone, wax and a salt.

24. The deformable pig as claimed in claim 17 wherein the shell is selected from the group consisting of fiber reinforced composites, polystyrene, metal and polymers selected from the group consisting of polyesters, polycarbonates, polyamides, and polyurethanes.

25. The deformable pig as claimed in claim 24 wherein the outer shell further comprises metal brushes.

26. The deformable pig as claimed in claim 17 wherein the deformable core material is bonded to the shell through a bond selected from the group consisting of covalent and non-covalent bonding.

27. The deformable pig as claimed in claim 17 wherein the deformable core material is a polystyrene mixed with a polymer selected from the group consisting of EVA, PVA, vinyl alcohol, ethylene EVOH and polyvinylidene chloride.

28. The deformable pig as claimed in claim 17 further comprising an outer shell that is fitted with sensors.

29. The deformable pig as claimed in claim 28 wherein the sensors are selected from the group consisting of sensors for monitoring corrosion, monitoring pipeline defect, pipeline imaging, and for generating power.

30. The deformable pig as claimed in claim 17 further comprising an outer shell loaded with a corrosion inhibitor.

31. The deformable pig as claimed in claim 17 wherein the shell is textured.

32. A method for cleaning a pipeline comprising pigging the pipeline with a pig comprising a deformable pig comprising an outer shell having a hollow, spherical shape and a deformable core material contained within the outer shell.

33. The method as claimed in claim 32 wherein the pig is launched into the pipeline from a pig launcher.

34. The method as claimed in claim 32 wherein the pig contacts interior walls of the pipeline.

35. The method as claimed in claim 32 wherein the pipeline contains a material selected from the group consisting of natural gas, refined products and crude oil.

36. The method as claimed in claim 32 wherein the method is performed at least on time per year.

37. The method as claimed in claim 32 wherein the pig is passing through the pipeline at speed of 10 to 17 feet per second

38. The method as claimed in claim 32 wherein the deformable core material is a shape memory effect polymer foam.

39. The method as claimed in claim 32 wherein the deformable core material comprises a material selected from the group consisting of polyurethanes, polysilicons and polyethylenes.

40. The method as claimed in claim 33 wherein the deformable core material further comprises a wax.

41. The method as claimed in claim 32 wherein the deformable core material comprises a polymer selected from the group consisting of polytetrafluoroethylene, polyactide and ethylene-vinyl acetate.

42. The method as claimed in claim 32 wherein the deformable core material comprises a silicone-wax hybrid.

43. The method as claimed in claim 42 wherein the silicone-wax hybrid is formed by combining silicone, wax and a salt.

44. The method as claimed in claim 1 wherein the outer shell is selected from the group consisting of fiber reinforced composites, polystyrene, metal and polymers selected from the group consisting of polyesters, polycarbonates, polyamides, and polyurethanes.

45. The method as claimed in claim 44 wherein the outer shell further comprises metal brushes.

46. The method as claimed in claim 32 wherein the deformable core material is bonded to the shell through a bond selected from the group consisting of covalent and noncovalent bonding.

47. The method as claimed in claim 32 wherein the deformable core material is a polystyrene mixed with a polymer selected from the group consisting of EVA, PVA, vinyl alcohol, ethylene EVOH and polyvinylidene chloride.

48. The method as claimed in claim 32 further comprising an outer shell that is fitted with sensors.

49. The method as claimed in claim 48 wherein the sensors are selected from the group consisting of sensors for monitoring corrosion, monitoring pipeline defect, pipeline imaging, and for generating power.

50. The method as claimed in claim 32 further comprising an outer shell loaded with a corrosion inhibitor.

51. The method as claimed in claim 32 wherein the shell is textured.

52. A method for maintaining a functional line for conveying fluid comprising introducing a deformable pig into the pipeline wherein the deformable pig comprises an outer shell having a hollow, spherical shape and a deformable core material contained within the outer shell.

53. The method as claimed in claim 52 wherein the pig is launched into the pipeline from a pig launcher.

54. The method as claimed in claim 52 wherein the pig contacts interior walls of the pipeline.

55. The method as claimed in claim 52 wherein the pipeline contains a material selected from the group consisting of natural gas, refined products and crude oil.

56. The method as claimed in claim 52 wherein the method is performed at least on time per year.

57. The method as claimed in claim 52 wherein the pig is passing through the pipeline at speed of 10 to 17 feet per second

58. The method as claimed in claim 52 wherein the deformable core material is a shape memory effect polymer foam.

59. The method as claimed in claim 52 wherein the deformable core material comprises a material selected from the group consisting of polyurethanes, polysilicons and polyethylenes.

60. The method as claimed in claim 59 wherein the deformable core material further comprises a wax.

61. The method as claimed in claim 52 wherein the deformable core material comprises a polymer selected from the group consisting of polytetrafluoroethylene, polyactide and ethylene-vinyl acetate.

62. The method as claimed in claim 52 wherein the deformable core material comprises a silicone-wax hybrid.

63. The method as claimed in claim 62 wherein the silicone-wax hybrid is formed by combining silicone, wax and a salt.

64. The method as claimed in claim 52 wherein the shell is selected from the group consisting of fiber reinforced composites, polystyrene, metal and polymers selected from the group consisting of polyesters, polycarbonates, polyamides, and polyurethanes.

65. The method as claimed in claim 64 wherein the outer shell further comprises metal brushes.

66. The method as claimed in claim 52 wherein the deformable core material is bonded to the shell through a bond selected from the group consisting of covalent and non-covalent bonding.

67. The method as claimed in claim 52 wherein the deformable core material is a polystyrene mixed with a polymer selected from the group consisting of EVA, PVA, vinyl alcohol, ethylene EVOH and polyvinylidene chloride.

68. The method as claimed in claim 52 further comprising an outer shell that is fitted with sensors.

69. The method as claimed in claim 68 wherein the sensors are selected from the group consisting of sensors for monitoring corrosion, monitoring pipeline defect, pipeline imaging, and for generating power.

70. The method as claimed in claim 52 further comprising an outer shell loaded with a corrosion inhibitor.

71. The method as claimed in claim 52 wherein the shell is textured.
